(19) United States
(12) Patent Application Publication
(10) Pub. No.: US 2018/0373801 A1
(43) Pub. Date: Dec. 27, 2018

(54) CONNECTIVITY AWARE MULTI-TAB MOBILE BROWSING WITH TIERED CACHING AND AUTO OFFLINE MODE

(71) Applicant: QUALCOMM Incorporated, San Diego, CA (US)

(72) Inventors: Robert NANCE, Solana Beach, CA (US); Bojin LIU, San Diego, CA (US); Enrico ROS, San Diego, CA (US)

(21) Appl. No.: 15/630,296

(22) Filed: Jun. 22, 2017

(51) Int. Cl. G06F 17/30; H04L 12/26; G06F 3/0483

(52) U.S. Cl. CPC G06F 17/30902; G06F 3/0483; H04L 43/0811

(57) ABSTRACT

Systems and methods for storage and retrieval of web content for view in a browser are disclosed. The method can be executed in a system supporting a plurality of tabs in a multi-tab browsing architecture. The method can include receiving a purge request to purge web content associated with a tab in a web browser. The system can determine that network connectivity to a wireless network is below a minimum threshold and based on the connectivity, the system can create a saved version of the web content associated with the first tab in a memory separate from the browser cache. The saved version can be recalled and displayed to a user in a low- or no-connectivity state, while the system reloads web resources associated with the desired page in the background, improving the user experience.

### BACKGROUND

### Technological Field

This disclosure relates to internet or web browsing tools and programs. More specifically, this disclosure relates to adaptively caching web-related information by making condition-based caching decisions based on a connectivity state.

### Related Art

Many mobile or desktop web browsers support multi-tab browsing. A user can open multiple “tabs” within a browser window simultaneously, allowing the user to freely switch between tabs, where each tab can load a different webpage. Web pages can be complex in terms of features, images, text, and other media, often requiring more and more resources and memory to render them in a user-friendly fashion.

Mobile devices may be limited in the amount of random access memory (RAM) available to support a browser having multiple open tabs at the same time. Not all of the open tabs can be kept in the memory (e.g., RAM) concurrently. If the total amount of memory exceeds a threshold, some pages may be purged from the memory to support a desired operation. If, for example, the user switches to a tab for which the data has recently been purged, the page will be loaded again automatically. Some of the purged tab's resources may still be present in the disk cache, which can accelerate reloading of the page. The page may also be marked to be refreshed on display or auto-refreshed at any time with same result.

If the tab for which the content has been purged is selected and there is limited or no wireless connectivity, the page associated with the purged tab may fail to load or remain blank for an extended period of time. This presents a contradiction to the expectation that since the page was recently loaded it should still be readily available.

Although many of the resources in the page may be cached in memory, some pages, such as website's main homepage, or the index.html page, are not cacheable by convention. Accordingly, each time the index.html page is selected, an updated version is downloaded them from the network. This can result in a failed pageload if connectivity is poor.

Some browsers provide an “offline mode” saving a given webpage to memory so that it can be loaded again from memory at times when there is no connectivity. The offline mode does not simply cache (e.g., save to memory) all of the webpage resources and links. Such an operation necessitates a transformation of the page to a format that does not have dependencies on external resources. Additionally, the page in offline mode can be saved as a different entity from the original page, so that it is not confused with the actual webpage, in the event the same page loaded again. Due to, among other things, different formats, increased processing requirements, memory, and storage of webpage resources, using a browser's offline mode requires affirmative user action. Further, saving all opening tabs in the offline mode for later use can increase workload and be difficult to manage.

### SUMMARY

In general, this disclosure describes systems and methods related to multi-tiered content caching and offline mode management for webpage and web browser management based on the connectivity status of a given device. The systems, methods and devices of this disclosure each have several innovative aspects, no single one of which is solely responsible for the desirable attributes disclosed herein.

One aspect of the disclosure provides a method for storage and retrieval of web content in a browser supporting a plurality of tabs in a multi-tab browsing architecture. The method can include receiving, at a resource retrieval agent (RRA), a purge request to purge web content associated with a first tab of the plurality of tabs from a browser cache. The method can include determining that network connectivity to a wireless network is below a minimum threshold. The method can include directing a memory controller to create a saved version of the web content associated with the first tab in a memory separate from the browser cache, based on the determining. The method can include causing the browser to purge the web content associated with the first tab from the browser cache. The method can include receiving, from the browser, a request to reload the web content associated with the first tab. The method can include reloading the web content associated with the first tab from the network if the network connectivity is above the minimum threshold. The method can include retrieving the saved version of the first tab if the network connectivity is at or below the minimum threshold.

Another aspect of the disclosure provides a device for storage and retrieval of web content in a browser supporting a plurality of tabs in a multi-tab browsing architecture. The device can have a memory configured to store at least one web page resource. The device can have a one or more processors operably coupled to the memory. The one or more processors can receive, at a resource retrieval agent (RRA), a purge request to purge web content associated with a first tab of the plurality of tabs from a browser cache separate from the memory. The one or more processors can determine that network connectivity to a wireless network is below a minimum threshold. The one or more processors can cause a memory controller to save a saved version of the web content associated with the first tab in the memory, based on the network connectivity. The one or more processors can cause the browser to purge the web content associated with the first tab from the browser cache. The one or more processors can receive, from the browser, a request to reload the web content associated with the first tab. The one or more processors can if the network connectivity is above the minimum threshold, reload the web content associated with the first tab from the network. The one or more processors can if the network connectivity is at or below the minimum threshold, retrieve the saved version of the first tab.

Another aspect of the disclosure provides an apparatus for storage and retrieval of web content in a browser supporting a plurality of tabs in a multi-tab browsing architecture. The apparatus can have means for receiving a purge request to purge web content associated with a first tab of the plurality of tabs from a browser cache. The apparatus can have means for determining that network connectivity to a wireless network is below a minimum threshold. The apparatus can have means for directing creation of a saved version of the web content associated with the first tab in a memory separate from the browser cache, based on the network connectivity. The apparatus can have means for causing the web content associated with the first tab to be purged from the browser cache. The apparatus can have means for receiving a request to reload the web content associated with the first tab. The apparatus can have means for reloading the web content associated with the first tab from the network if the network connectivity is above the minimum threshold. The apparatus can have means for retrieving the saved version of the first tab, if the network connectivity is at or below the minimum threshold.

Another aspect of the disclosure provides a non-transitory computer-readable medium comprising instructions for storage and retrieval of web content in a browser supporting a plurality of tabs in a multi-tab browsing architecture. When executed the instructions cause a processor to receive, at a resource retrieval agent (RRA), a purge request to purge web content associated with a first tab of the plurality of tabs from a browser cache. The instructions can cause the processor to determine that network connectivity to a wireless network is below a minimum threshold. The instructions can cause the processor to direct a memory controller to create a saved version of the web content associated with the first tab in a memory separate from the browser cache, based on the determining. The instructions can cause the processor to cause the browser to purge the web content associated with the first tab from the browser cache. The instructions can cause the processor to receive, from the browser, a request to reload the web content associated with the first tab. The instructions can cause the processor to reload the web content associated with the first tab from the network if the network connectivity is above the minimum threshold. The instructions can cause the processor to retrieve the saved version of the first tab if the network connectivity is at or below the minimum threshold.

Other features and advantages of the present disclosure should be apparent from the following description which illustrates, by way of example, aspects of the disclosure.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a functional block diagram of a system for content management;

FIG. 2 is a signal flow diagram of a first scenario for recalling webpage resources using the system of FIG. 1;

FIG. 3 is a signal flow diagram of a second scenario for recalling webpage resources using the system of FIG. 1;

FIG. 4 is a signal flow diagram of a third scenario for recalling webpage resources using the system of FIG. 1;

FIG. 5 is a signal flow diagram of a fourth scenario for recalling webpage resources using the system of FIG. 1; and

FIG. 6 is functional block diagram of a device that can implement system of FIG. 1

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that the disclosure without these specific details. In some instances, well-known structures and components are shown in simplified form for brevity of description.

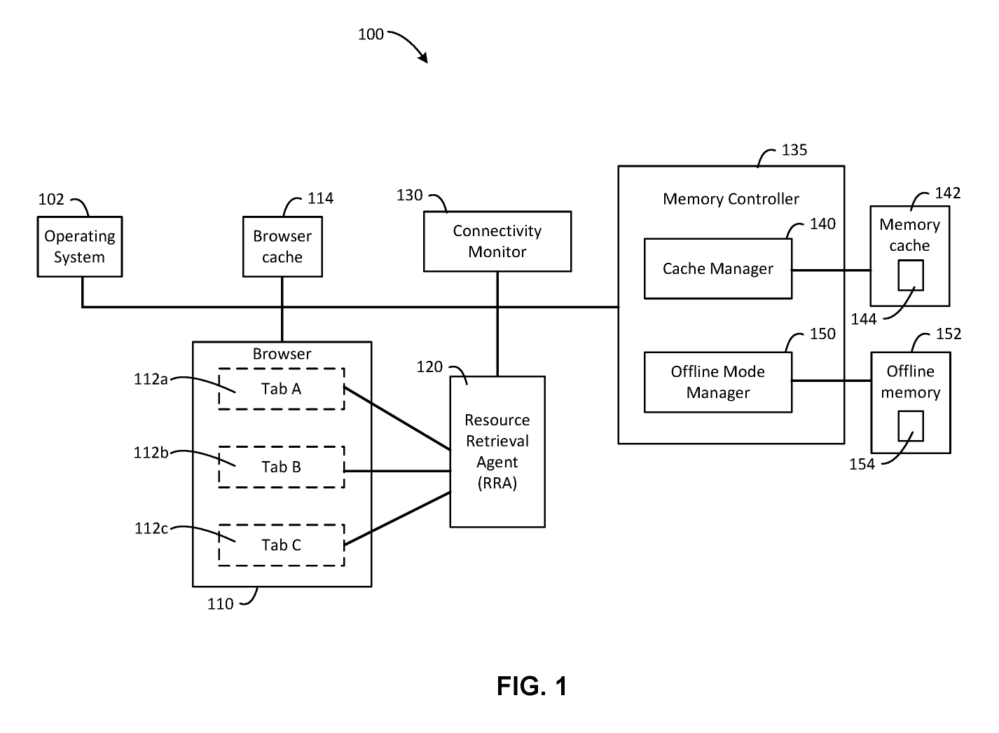

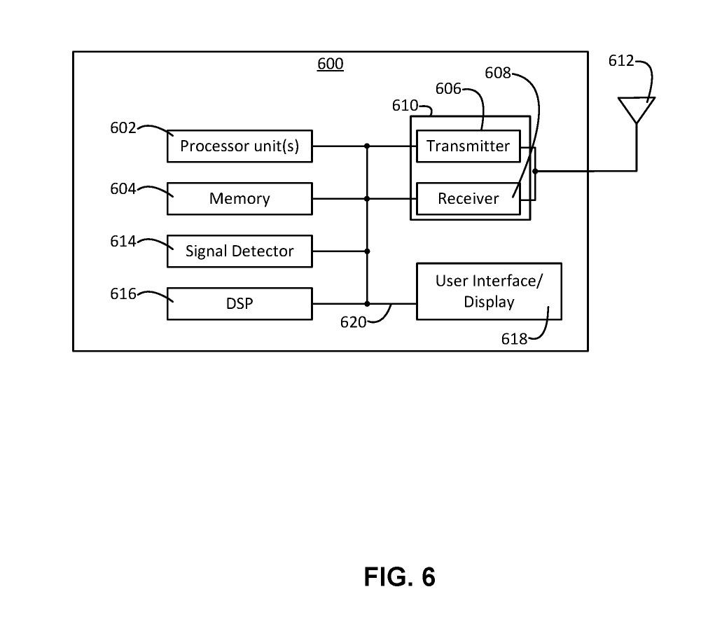

FIG. 1 is a functional block diagram of a system for content management. A system 100 can perform various tasks within a computing device 600 (see FIG. 6). The computing device can have an operating system (OS) 102 that can manage hardware (e.g., a user interface, a display, peripheral equipment, etc.) and software resources and perform various tasks to manage overall performance of the device 600.

The system 100 can have a browser 110 (e.g., web browser). The browser 110 can have multiple tabs 112 for browsing in the internet, for example. The browser 110 can store web content, web page resources, or other data associated with a webpage to a browser cache 114 for later retrieval or recall. As used herein, web resources are anything that can be obtained from the Internet, or the World Wide Web, for example. Some examples are web pages, e-mail, information from databases, and web services. Web resources can include static (e.g., non-moving) files or documents or other dynamic elements accessible via for example, a uniform resource locators or URLs.

The browser 110 can be coupled to a resource retrieval agent (RRA) 120. The RRA 120 can cooperate with the browser 110 to conduct certain pageload events, such as start pageloading, finish pageloading, purge page content from memory (e.g., from the browser cache 114), and switch to a tab 112 that has been purged, among other features and capabilities disclosed herein. Some processes can be directed or requested by the OS 102, for example.

The RRA 120 can be coupled to a connectivity monitor 130. The connectivity monitor 130 can observe or track connectivity state (to e.g., the Internet or other network) and provide information to the RRA 120 with respect to internet or network connectivity. The RRA 120 can be coupled to a memory controller 135. The memory controller 135 can have a cache manager 140 and an offline mode manager 150. The cache manager 140 can provide information to the RRA 120 regarding the status and availability of memory (e.g., RAM) in addition to providing read/write operations for the Internet content of the tabs 112 to memory. The cache manager 140 can be a separate resource cache apart from the disk cache (e.g., browser cache 114) associated with the browser 110. The offline mode manager 150 can create or destroy (e.g., purge from memory) “offline mode” or saved versions of tab 112 content based on connectivity state and commands from the RRA 120.

In some embodiments, the system 100 can allow a user to open many tabs 112. In some instances, the number of tabs 112 may exceed a capacity of random access memory (RAM), or the browser cache 114, for example, within the system 100. The system 100 can provide the ability to switch to any previously accessed tab 112 and immediately display the related page content, regardless of whether the tab 112 resources have been purged from the browser cache 114. This capability is provided even under poor connectivity or no connectivity conditions. In some embodiments, poor connectivity can be determined based on a minimum connectivity threshold. The minimum connectivity threshold can be a minimum data throughput needed to support transmission and reception operations regarding necessary web content or other resources. For example, such a minimum data throughput can be approximately 10 kilobytes per second (KB/s), such as that associated with a typical 2G data speed. This minimum data throughput is also referred to herein as “low-” or “poor connectivity.” In some embodiments, the minimum threshold, as used herein, can be predetermined or set manually.

The system 100 can further provide an interface allowing smooth scrolling and tab swiping. The system 100 can provide an automatic reloading of previously purged information or resources to allow such an interface. For example, such a feature may not be available in some systems due to RAM exceedances (from multiple open tabs 112) and the need to purge resources related to previously viewed tabs 112 from memory.

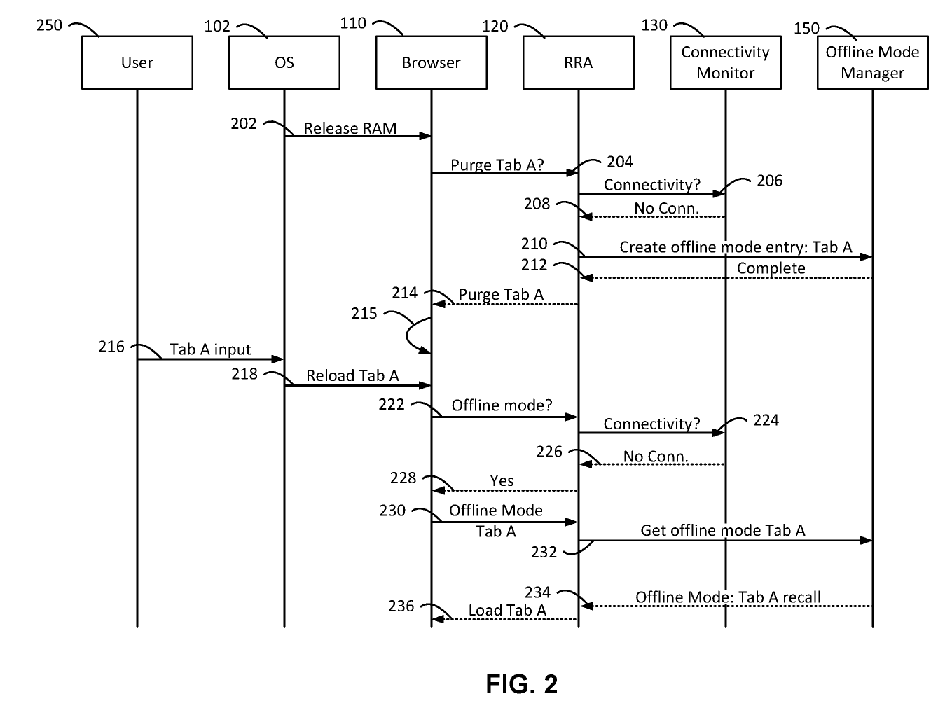

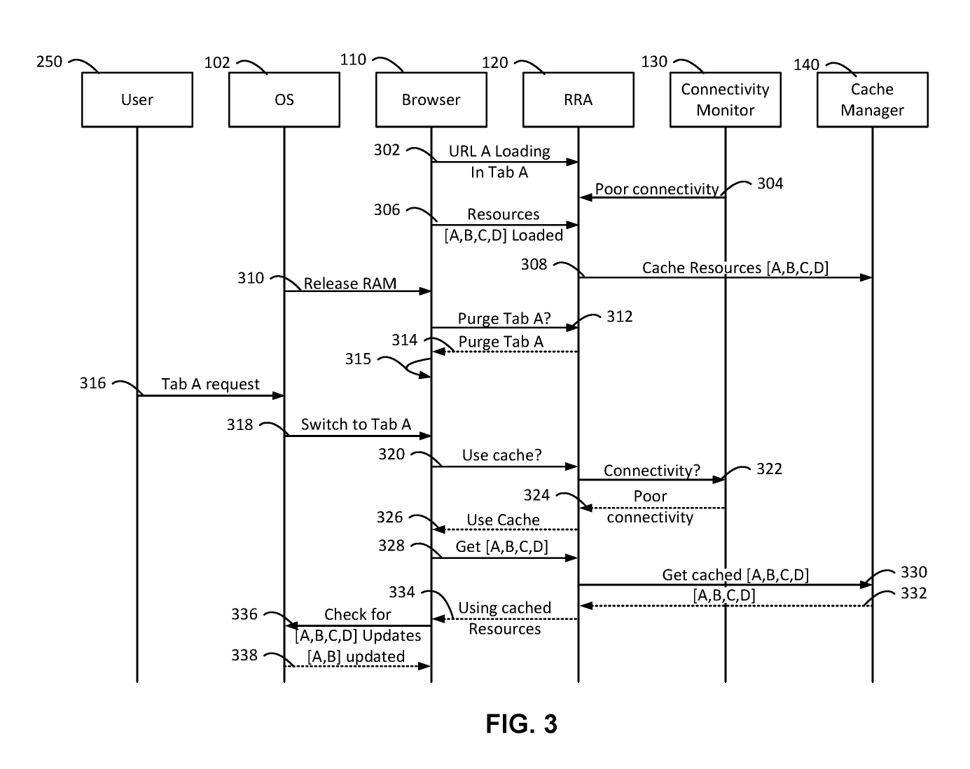

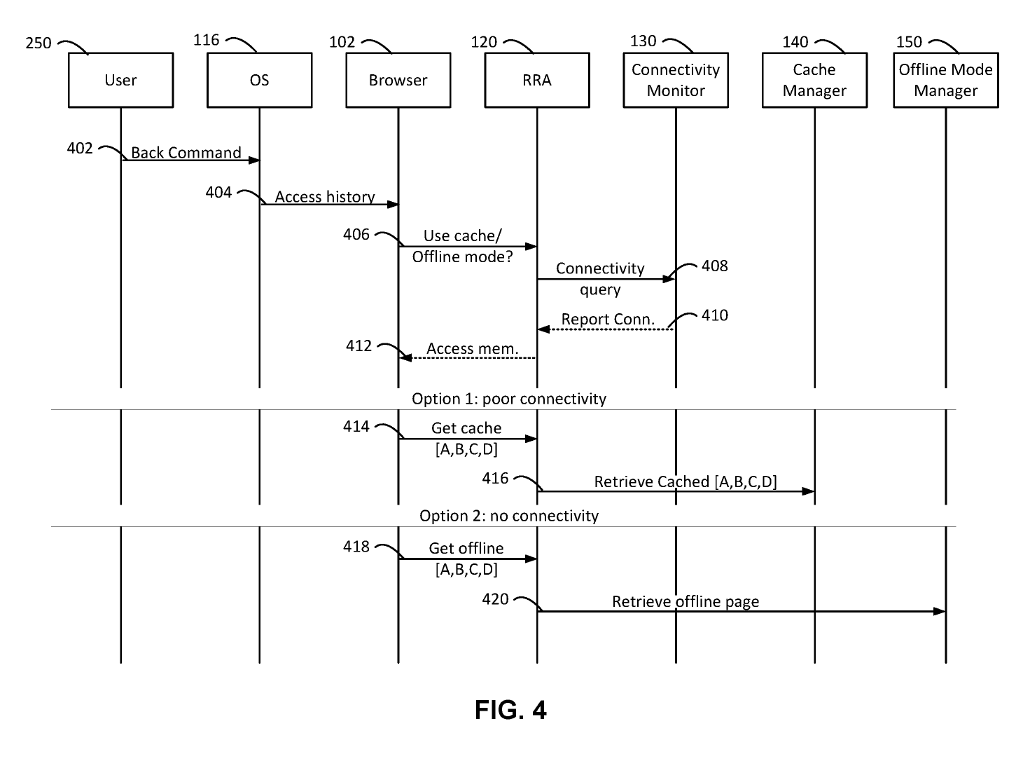

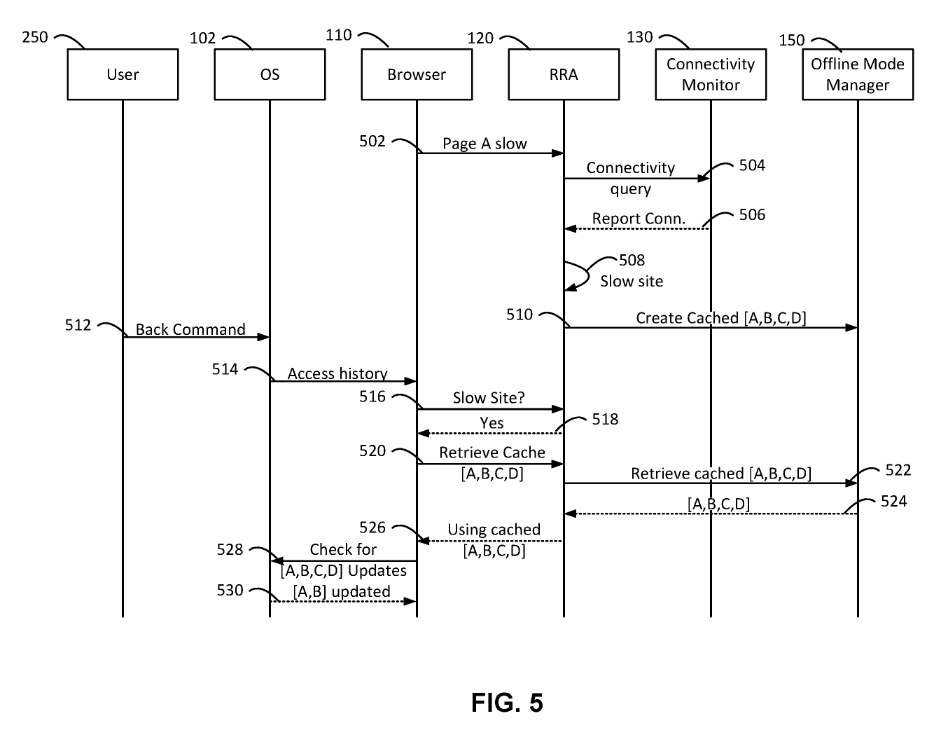

FIG. 2 is a signal flow diagram of a first scenario for recalling webpage resources using the system of FIG. 1. The steps of the method associated with the signal flow diagram of FIG. 2 and the following signal flow diagrams of FIG. 3, FIG. 4, and FIG. 5 may be executed by the component of the system 100 described in the associated description or as indicated in the respective figure.

A first scenario depicted in FIG. 2 assumes a webpage was loaded in the tab 112a (for example) at a time when the system had full network connectivity. The scenario of FIG. 2 describes communication within the system 100 that occurs as web resources associated with the webpage of the tab 112a are purged from the memory associated with the browser 110, for example, the browser cache 114. The content of the purged tab 112a is then later recalled at a time when network connectivity has diminished.

The scenario of FIG. 2 can begin as a random access memory (RAM) exceedance is encountered. The OS 102 can transmit a RAM release request 202 to the browser 110 to release RAM and decrease the amount of memory used, making it available for other functions. The browser 110 can transmit a purge query 204 to the RRA 120 to determine whether the first tab 112a (e.g., Tab A) is required to be maintained in memory (e.g., the browser cache 114). If Tab A is active or needed, then the browser 110 may select a different tab 112 to purge. If Tab A is not active or the associated resources are not required, the RRA 120 can then transmit a connectivity query 206 to the connectivity monitor 130 to confirm whether there is sufficient connectivity to reload the first tab 112a if needed. If there is no connectivity, the connectivity monitor 130 can respond by transmitting a no connectivity response 208 to the RRA 120.

Based on the absence of connectivity, the RRA 120 can then transmit a save content instruction 210 to the offline mode manager 150 to create an offline mode entry 154 (FIG. 1) for page resources (or other data) associated with the first tab 112a (Tab A). The offline mode manager 150 can then save the first tab 112a and the data and page resources associated with Tab A to the offline memory 152 as the offline mode entry 154. The offline mode manager 150 can then transmit a save complete message 212 back to the RRA 120 when the saving process is complete.

Once the resources for the first tab 112a have been saved to the offline memory 152, the RRA 120 can cause or otherwise direct the resources for the first tab 112a (Tab A) to be purged 215 from the browser cache 114 using a purge instruction 214.

A period of time later, the OS 102 can receive a Tab A request input 216 (from, e.g., the user 250) indicating that the first tab 112a needs to be reloaded. The OS 102 can, in response to the Tab A request input 216, transmit a reload Tab A instruction 218 to the browser 110. The browser 110 can then determine, via the RRA 120 whether the offline mode entry 154 is required with an offline mode query 222. The RRA 120 can, in turn, query the connectivity monitor 130 using a connectivity status request 224. The connectivity monitor 130 can respond with a connectivity status message 226 indicating that there is no network connectivity. The RRA 120 can indicate 228 the connectivity status message to the browser 110. In response, the browser 110 can transmit a load offline mode request 230 to retrieve the offline mode entry 154 for the first tab 112a.

The RRA 120 can then transmit a load instruction 232 for the data and resources associated with the first tab 112a. The offline mode manager 150 can access the offline memory 152 to recall 234 the offline mode entry 154 for the first tab 112a. The RRA 120 can then load 236 the offline mode entry 154 of the web content/resources of the tab 112a. This can decrease the amount of time required to reload a requested webpage, even in the absence of a usable wireless network connection.

The scenario of FIG. 2 allows the system 100 to save memory because it is more process-intensive to create, load, and delete offline-mode pages for every tab 112, given the extra processing and format transformation that may be required to save an entire page and associate resources. Accordingly, the scenario of FIG. 2 is advantageous in a no-connectivity state.

FIG. 3 is a signal flow diagram of a second scenario for recalling webpage resources using the system of FIG. 1. In the scenario of FIG. 3, the system 100 can have poor connectivity. In such a state, resources within the tabs 112 may require more time to download. Thus in a poor or low-connectivity state, priority can be given to saving or caching certain resources associated with open tabs 112, for example. Such priority can also be assigned to caching otherwise “non-cacheable” resources for a predetermined or limited time. Such a predetermined or limited time can be programmable (e.g., 1 minute, 1 hour, 1 day) to a desired period of time. In some examples, the predetermined time can be readily reset or adjust as needed. The predetermined time can also be according to user preferences.

In some examples, a main page of a given website (e.g., the index.html) may not be cacheable by convention. This can be because, for example, the resources on the main page are constantly updated or automatically updated, (e.g., with news or banner offers) and the webpage owner prefers that it be loaded every time it is accessed to ensure the most current information is displayed. However, an embodiment of this disclosure, the main page can be translated to a different format and saved for later recall. The different format can be any format the browser 110 can use to re-display the page. For example, the main page can be translated into an expanded HTML page with CSS rules inlined. In another example, the main page can be translated in an in-memory document object model (DOM) object serialized and saved to memory for later recall. In some embodiments, the translated main page can be saved to a memory cache 142 (FIG. 1) separate from the browser cache 114. Such pages and their associated resources may be referred to herein as the “actual” page or “non-cacheable” page or resources, for example. The browser 110 can then, even in a limited connectivity situation, rapidly load a “cached” version of the purged web content. If after the predetermined time noted above there is a change in the actual “non-cacheable” content, that data or resources can be updated. If the page itself has an auto-refresh feature, it may be disabled for the “noncacheable” resources. The RRA 120 and the browser 110 can, however, indicate such a condition to the user as needed. This can provide a more responsive user experience under limited connectivity without the memory cost and complexity of triggering an “offline mode.” The user is further guaranteed the most up-to-date web content at the end of the process.

The scenario of FIG. 3 can begin when the RRA 120 receives an indication 302 that the browser 110 is loading web resources associated with a webpage in the first tab 112a. The RRA 120 receives a connection status indication 304 of a poor network connection from the connectivity monitor 130. “Poor” connection status can indicate, for example, no connection or insufficient network speed to load the requested resources for the web page. In some examples, “poor” connection status can be a threshold set by a preference. For example, such a poor connection may be 2 kilobits per second (kbps). In some other examples, the poor connection speed can be less than 10 kpbs or as set by preferences.

As webpage resources A, B, C, and D, for example, load in the first tab 112a, the browser 110 can transmit a resources loaded indication 306 to the RRA 120. The RRA 120 can then transmit a cache resources instruction 308 to the cache manager 140, to prompt the creation of a cached version 144 of the desired web page resources, or the resources [A, B, C, D], for example. This can be based on the connection status indication 304. The RRA 120 can cause or direct such a process. As the web resources A, B, C, D are cached, the cache manager 140 can assign a priority to the saved data. The priority can indicate a relative importance of the data, so that it remains in the cache for longer than other data that may have a lower priority, for example. The more limited the connectivity, the higher priority the RRA 120 can assign to the webpage (or tab) resources (e.g., [A,B,C,D]).

The non-cacheable resources can be translated into a different format and stored by the cache manager 140 to the memory cache. In some embodiments, this can be similar to above as the non-cacheable resources can be translated into a format that the browser 110 can use to readily redisplay the resource, such as HTML, base64 encoded images, serialized object, etc.

The browser 110 can then receive a release RAM instruction 310 from the OS 102, for example, indicating that the browser 110 should make room in the memory (e.g., RAM, browser cache 114, etc.). This can be similar to the RAM release request 202 (FIG. 2). In response, the browser 110 can transmit a purge query 312 to the RRA 120 requesting to purge the contents of the first tab 112a, for example. If the first tab 112a, or Tab A, is not in use or not needed, then the RRA 120 can respond to the purge query 312 with a purge instruction 314 indicating that the browser 110 can (or should) purge 315 to release RAM. The resources purged in response can be a function of the priorities set by the cache manager 140.

The user 250 can later select Tab A, via a Tab A request 316 on a user interface, for example, requiring that the system 100 reload the resources [A,B,C,D] associated with the first tab 112a. In response, the OS 102 can send a Tab A recall instruction 318 to the browser 110 to switch to Tab A (e.g., the first tab 112a). Ordinarily, since the resources [A,B,C,D] were previously purged, the system 100 would have to reload the resources from the network which cannot be done given a low-connectivity state (as noted above in e.g., connection status indication 304).

In response to the recall instruction 318, the browser 110 can transmit a use cache query 320 to determine if the connectivity is still poor. The RRA 120 can then send a connectivity query 322 to the connectivity monitor and receive a connectivity status message 324 indicating that the connectivity is still poor. The RRA 120 can then transmit a use cache 326 to cause or otherwise direct the browser 110 to use the cached version of the resources [A,B,C,D] associated with the first tab 112a.

The browser 110 may then transmit a get resource request to the RRA 120 to retrieve the resources [A,B,C,D] for the first tab 112a from memory (e.g. the memory cache 142). The RRA 120 can then transmit a memory retrieval instruction 330 to the cache manager 140 to retrieve the cached version of the request resources [A,B,C,D]. As the cached resources are returned 332, the RRA 120 can pass such resources back to the browser 110 for loading into Tab A. The browser 110 can then request any updates from the OS 102 and the network. If there is a suitable connection, or a connection that is not considered “poor” as used herein, one or more of the resources [A,B,C,D] can be updated.

In some embodiments, the RRA 120 can provide the “cached” non-cacheable resources first (e.g., index.html) from the cache manager 140 to the browser 110 so that the user receives at least a portion of the requested information. The browser 110 can then begin to load other page resources associated with the tab 112a immediately. The actual information associated with the index.html page can then be fetched from the network (e.g., in the background) as the cached resources are loaded. The tab 112a can then be updated when there are differences between the freshly fetched page resources of tab 112a versus the translated version of the “non-cacheable” (but cached anyway) page.

As a result, even though the main page (e.g., index.html) is not ordinarily cacheable, the browser 110 can still display the “cached” version immediately in limited connectivity conditions. If after a long time there is a change in the actual or “non-cacheable” content, the browser 110 can update the resources in the tab 112a. This provides a responsive user experience under limited connectivity conditions without the cost and complexity of triggering the offline mode. Certain elements of the scenario of FIG. 3 can be combined with the foregoing examples described in connection with FIG. 2 as needed.

FIG. 4 is a signal flow diagram of a third scenario for recalling webpage resources using the system of FIG. 1. In the scenario of FIG. 4, the user can actuate a “back button” (or Recent History links) within the browser 110, requesting a previously viewed (and/or now-purged) webpage. Certain processes of the scenario of FIG. 2 or the scenario of FIG. 3 can be implemented in the scenario of FIG. 4. If the browser 110 receives a “back” command in a low-connectivity state, the RRA 120 can load the cached version 144 of the requested page. In a no-connectivity state, the RRA 120 can load an offline mode version (e.g., the offline mode entry 154) of the page. These two options are similar to the preceding scenario of FIG. 2 and the scenario of FIG. 3, incorporating many similar aspects. This can aid in the circumstance that a user inadvertently selects a link that navigates away from the desired page. The “back” command can load a saved version of the page, while new or updated page is reloaded in, for example, a background process. The user 250 may be informed that the loaded page is the cached version 144, for example, and that a refresh process is pending as or when the connection improves. If the webpage resources are cacheable, then the browser 110 can retrieve those resources from the browser cache 114, for example. However, when webpage resources are related to non-cacheable assets (e.g., non-cacheable resources) associated with the main page (e.g., index.html), for example, those non-cacheable resources may not be stored in the browser cache 114.

The user 250 can click a link on a webpage displayed by the browser 110 and then decide that the click was not desired or was a mistake, for example. A back command 402 may be initiated via a user interface (see FIG. 6). The back command 402 can be received at the OS 102. In response, the OS 102 can transmit an access history instruction 404 to the browser 110. The browser 110 can transmit a query 406 to the RRA 120 to determine whether the cached version 144 of the desired page resources or an offline mode version 154 of the page resources is required. This can depend on the level of network connectivity that is available. The RRA 120 can transmit a connectivity query 408 to the connectivity monitor 130. The connectivity monitor 130 can respond to the RRA 120 with a connectivity report 410 indicating low/poor connectivity or no connectivity. In some embodiments, the poor or no connectivity state can be characterized by one or more of a low bandwidth or data throughput of less than about 10 kpbs, or long delays (e.g., ping time) to certain public websites (e.g., google.com). The RRA 120 can then indicate 412 to the browser 110 that a saved version (e.g., the cached version 144 or other offline mode entry 154) of the desired page resources (e.g., resources [A,B,C,D]) is needed from memory for example, the memory cache 142 or the offline memory 152.

The connectivity report 410 can indicate that network connectivity is available, but it may be limited (e.g., poor connectivity). Accordingly, browser 110 can transmit an access memory instruction 414 to the RRA 120 to access the memory cache 142. The RRA 120 can transmit a retrieval request 416 to load the cached version 144 of the desired page resources [A,B,C,D], for example. This is similar to the memory retrieval instruction 330 of the scenario of FIG. 3. The scenario of FIG. 4 can then proceed similarly to the scenario of FIG. 3 and load cached versions of the page resources [A,B,C,D] for display on the user interface (FIG. 6) the resources can be updated.

In the event the connectivity report 410 indicates no network connectivity, the browser 110 can transmit an access memory instruction 418 to the RRA 120 to access the offline memory 152. The RRA 120 can transmit a retrieval request 420 to load the offline mode entry 154 of the desired page resources [A,B,C,D], for example. This is similar to the load request 232 of the scenario of FIG. 2. The scenario of FIG. 4 can then proceed similarly to the scenario of FIG. 2 and load offline versions of the page resources [A,B,C,D] for display on the user interface (FIG. 6) until connectivity improves and the resources can be updated. Certain elements of the scenario of FIG. 5 can be combined with the foregoing examples described in connection with FIG. 2, and FIG. 3 as needed.

FIG. 5 is a signal flow diagram of a fourth scenario for recalling webpage resources using the system of FIG. 1. In the scenario of FIG. 5, the browser 110 can have the first tab 112a showing web content from a generally slow website. The website may be considered “slow” if a particular site is known to load slowly on a given device, or, for example, if the web content is memory- or process-intensive. The RRA 120 can save certain load-speed history information or average page load speeds for certain websites along with associated cached resources. These speeds can be referenced in, for example, bits per second (bps). Similar to above, poor connectivity or slow page load speeds can be characterized by long delays and slow ping times in addition to minimal data throughput. The RRA can determine a page load speed of a current web page associated with the first tab 112a, for example, and compare it to the historical page load or average page load information, such as page load speed. The RRA 120 can then save a cached or stored version of a requested website based on such a comparison. For example, if the page load speed of the current web page is slower than average, the RRA 120 can determine that the current web page is “slow” and cache certain resources for later use. The RRA 120 may then save at least a portion of the web data (e.g., an old rendering or “old resource”) and display the saved/cached data until at least some of the updated content is ready for display. The updated data may not be identical to the previous or stored content. For example, the “old resources” associated with the slow web page can be saved, used temporarily when recalled, and then replaced by updated resources when they become available.

The scenario of FIG. 5 can begin as the browser 110 sends a page slow indication 502 to the RRA 120. Similar to above, the page slow indication can indicate when the delay or ping time is long or the data throughput is low, for example, less than a few kpbs. In response, the RRA 120 can transmit a connectivity query 504 to the connectivity monitor 130 to determine the network connectivity. The connectivity monitor 130 can respond with a connectivity report, indicating, for example, good connectivity that is sufficient to support loading resources. Given that the page is loading slower than it should, and connectivity is sufficient to support the operation, the RRA 120 can register 508 the website as a slow site. Thereafter, the RRA 120 can send a cache instruction 510 to the offline mode manager 150 to create cached versions of web page resources [A,B,C,D] for example. This can allow the RRA 120 to predictively determine whether to save or cache certain resources based on previous browsing or page load history.

In an embodiment, the user 250 can then indicate a back command 512 (via a user interface, for example) to the OS 102. The browser 110 can then receive an access history request 514 and determine if the requested site is registered as a “slow site” with a query 516. The RRA 120 can send a slow site response 518 indicating that the webpage associated with the user request (e.g., the back command 512) is registered as a slow site. The browser 110 can then transmit a retrieve cache request 520 to the RRA 120 indicating the need for the cached resources. The RRA 120 can then transmit a retrieve cache instruction 522 to the offline mode manager 150 to recall the cached versions (e.g., the cached version 144) of the resources [A,B,C,D] saved in response to the cache instruction 510. The offline mode manager 150 can then transmit a message 524 including the cached resources [A,B,C,D] back to the RRA 120.

The browser 110 can then receive 526 and load the cached resources [A,B,C,D] for the desired webpage. As the browser 110 loads the cached resources and presents the desired webpage to the user, the browser 110 can also check for any updates to the loaded resources in the background. For example, if the cached resources [A,B,C,D] for the slow site are loaded in response to the back command 512, the browser can also check for updates to any of the resources that have been implemented since the cache instruction 510. This may include updating only some of the resources (e.g., [A,B]) or updating all of the resources gradually. This arrangement can provide a faster presentation (to the user 250) of the page even in the presence of a slow site. This can also maximize the use of bandwidth as the browser does not have to wait to request, receive, and load all of the resources [A,B,C,D] from the slow site; it need only reload those that have been recently updated, such as [A,B]. Certain elements of the scenario of FIG. 5 can be combined with the foregoing examples described in connection with FIG. 2, FIG. 3, and FIG. 4 as needed.

FIG. 6 is a functional block diagram of a device for use with the system of FIG. 1 and the scenarios of FIG. 2, FIG. 3, FIG. 4, and FIG. 5 each of which have similar aspects and can be combined with one another in whole or in part. A wireless device 600 is an embodiment of a device that can be configured to implement the various methods described herein. For example, the wireless device 600 can include the system 100 (FIG. 1).

The wireless device 600 can include a processor 602. The processor 602 can be implemented as one or more processors or processor units 602. The processor 602 can also be referred to as a central processing unit (CPU). The processor 602 can control operation of the wireless device 600. The processor 602 can implement the steps of the methods described in the first scenario of FIG. 2, the second scenario of FIG. 3, the third scenario of FIG. 4, and the fourth scenario of FIG. 5. The processor 602 can perform the tasks associated with any one of the OS 102, the browser 110, the RRA 120, the connectivity monitor 130, the memory controller, the cache manager, and the offline mode manager 150. The processor 602 can perform the various steps within the foregoing signal flow diagrams, combining, overlapping, repeating, or performing them out of order as needed. For example, as noted above, at least the scenario of FIG. 4 can be combined with one or both of the scenarios of FIG. 2 and FIG. 3.

The wireless device 600 can also have a memory 604 coupled to the processor 602. The memory 604 can include both read-only memory (ROM) and random access memory (RAM). The memory 604 can provide instructions and data to the processor 602. At least a portion of the memory 604 can also include non-volatile random access memory (NVRAM). The processor 602 can perform logical and arithmetic operations based on program instructions stored within the memory 604. The instructions in the memory 604 can be executable to implement the methods described herein. In some embodiments, the memory 604 can be implemented as the browser cache, the memory cache 142, and/or the offline memory 152. In some other embodiments, the memory 604 can also be implemented to store, for example, the cached version 142 or the offline mode entry 154.

The processor 602 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processor 602 and the memory 604 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 600 can also include a transmitter 606 and/or a receiver 608 to allow transmission and reception of data between the wireless device 600 and a remote location via, for example, a network connection associated with the network connectivity described herein. The transmitter 606 and the receiver 608 can be combined into a transceiver 610. The wireless device 600 can also have one or more antennas 612 electrically coupled to the transceiver 610. The wireless device 600 can also include (not shown) multiple transmitters, multiple receivers, multiple transceivers, and/or multiple antennas as needed for various communication standards.

The transmitter 606 can be configured to wirelessly transmit packets having different packet types or functions. For example, the transmitter 606 can be configured to transmit packets of different types generated by the processor 602.

The receiver 608 can be configured to wirelessly receive packets having different packet types. In some examples, the receiver 608 can be configured to detect a type of a packet used and to process the packet accordingly.

In some embodiments, the transmitter 606 and the receiver 608 can be configured to transmit and receive information via other wired or wireline systems or means.

The wireless device 600 can also include a signal detector 614 that can be used in an effort to detect and quantify the level of signals received by the transceiver 610. The signal detector 614 can detect such signals as total energy, energy per subcarrier per symbol, RSSI, SNR, power spectral density, and other signals pertaining to the factors described above. The wireless device 600 can also include a digital signal processor (DSP) 616 for use in processing signals. The DSP 616 can be configured to generate a packet for transmission.

The wireless device 600 can further include a user interface 618. The user interface 618 can include a keypad, a microphone, a speaker, a touchscreen, and/or a display. The user interface 618 can include any element or component that conveys information to a user of the wireless device 600 and/or receives input from the user. Thus the user 250 can interact with the device 600 via the user interface 618 to use the “go back” button to initiate the back command as in the back command 402 and the back command 512.

The various components of the wireless device 600 can be coupled together by a bus system 620. The bus system 620 can include a data bus, for example, as well as a power bus, a control signal bus, and a status signal bus in addition to the data bus. The components of the wireless device 600 can be coupled together or accept or provide inputs to each other using some other mechanism.

Although a number of separate components are illustrated in FIG. 6, one or more of the components can be combined or commonly implemented. For example, the processor 602 can be used to implement not only the functionality described above with respect to the processor 602, but also to implement the functionality described above with respect to the signal detector 614 and/or the DSP 616. In some embodiments, each of the components illustrated in FIG. 5 can be implemented using a plurality of separate elements.

Those of skill will appreciate that the various illustrative logical blocks (e.g., the various servers described herein), modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the disclosure. In addition, the grouping of functions within a module, block or step is for ease of description. Specific functions or steps can be moved from one module or block without departing from the disclosure.

The various illustrative blocks (e.g., the various system components described herein) described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

It will be understood that the above descriptions of various embodiment are given by way of example and not by limitation. Accordingly, various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this disclosure.

The above description of the disclosed embodiments is provided to enable any person skilled in the art to make or use the subject matter disclosed. Various modifications to these embodiments will be readily apparent to those skilled in the art, and the generic principles described herein can be applied to other embodiments without departing from the spirit or scope of the disclosure. Thus, it is to be understood that the description and drawings presented herein represent a presently preferred embodiment of the disclosure and are therefore representative of the subject matter, which is broadly contemplated. It is further understood that the scope of the present disclosure fully encompasses other embodiments that may become obvious to those skilled in the art.

What is claimed is:

1. A method for storage and retrieval of web content in a browser supporting a plurality of tabs in a multi-tab browsing architecture, the method comprising:
receiving, at a resource retrieval agent (RRA), a purge request to purge web content associated with a first tab of the plurality of tabs from a browser cache;
determining that network connectivity to a wireless network is below a minimum threshold;
directing a memory controller to create a saved version of the web content associated with the first tab in a memory separate from the browser cache, based on the determining;
causing the browser to purge the web content associated with the first tab from the browser cache;
receiving, from the browser, a request to reload the web content associated with the first tab;
if the network connectivity is above the minimum threshold, reloading the web content associated with the first tab from the network; and
if the network connectivity is at or below the minimum threshold, retrieving the saved version of the first tab.

2. The method of claim 1 wherein the saved version comprises an offline mode version of the web content.

3. The method of claim 1 further comprising updating one or more webpage resources associated with the first tab, wherein the saved version comprises a cached version of the one or more webpage resources, each webpage resource of the one or more webpage resources having a priority based on the network connectivity.

4. The method of claim 3 wherein the saved version further comprises a cached version of non-cacheable webpage resources, the non-cacheable webpage resources comprising webpage resources that are not cacheable by convention.

5. The method of claim 1 further comprising receiving a back command causing the browser to reload the web content associated with the first tab.

6. The method of claim 1 wherein the purge request is associated with a closed tab.

7. The method of claim 1 further comprising:
loading the web content associated with the first tab and determining a current page load speed;
comparing the current page load speed to an average page load speed;
determining, based on the comparing, that the web content of the first tab is associated with a slow website,
designating, based on the determining, the website as a slow website; and
creating a cached version of resources associated with the slow website.

8. The method of claim 1 wherein the determining comprises:
transmitting a first connectivity query to a connectivity monitor following the purge request; and
receiving a first connectivity status message from the connectivity monitor, based on the first connectivity query, the first connectivity status message indicating insufficient network connectivity to load additional web content.

9. A device for storage and retrieval of web content in a browser supporting a plurality of tabs in a multi-tab browsing architecture, the device comprising:
a memory configured to store at least one web page resource; and
one or more processors operably coupled to the memory and configured to:
receive, at a resource retrieval agent (RRA), a purge request to purge web content associated with a first tab of the plurality of tabs from a browser cache separate from the memory,
determine that network connectivity to a wireless network is below a minimum threshold,
cause a memory controller to save a saved version of the web content associated with the first tab in the memory, based on the network connectivity,
cause the browser to purge the web content associated with the first tab from the browser cache;
receive, from the browser, a request to reload the web content associated with the first tab;
if the network connectivity is above the minimum threshold, reload the web content associated with the first tab from the network; and
if the network connectivity is at or below the minimum threshold, retrieve the saved version of the first tab.

10. The device of claim 9 wherein the saved version comprises an offline mode version of the web content associated with the first tab saved to the memory.

11. The device of claim 9 wherein the one or more processors is further configured to update one or more webpage resources associated with the first tab, wherein the saved version comprises a cached version of the one or more webpage resources, each webpage resource of the one or more webpage resources having a priority based on the network connectivity.

12. The device of claim 11 wherein the saved version further comprises a cached version of non-cacheable webpage resources, the non-cacheable webpage resources comprising webpage resources that are not cacheable by convention.

13. The device of claim 9 wherein the one or more processors is further configured to receive a back command and cause the browser to reload the web content associated with the first tab.

14. The device of claim 9 wherein the purge request is associated with a closed tab.

15. The device of claim 9 wherein the one or more processors is further configured to:
load the web content associated with the first tab and determine a current page load speed;
compare the current page load speed to an average page load speed;
determine based on the comparison, that the web content of the first tab is associated with a slow website,
designate the website as a slow website; and
create a cached version of resources associated with the slow website.

16. The device of claim 9 wherein the one or more processors is further configured to:
transmit a first connectivity query to a connectivity monitor following the purge request; and
receive a first connectivity status message from the connectivity monitor, based on the first connectivity query, the first connectivity status message indicating insufficient network connectivity to load additional web content.

17. An apparatus for storage and retrieval of web content in a browser supporting a plurality of tabs in a multi-tab browsing architecture, the apparatus comprising:
means for receiving a purge request to purge web content associated with a first tab of the plurality of tabs from a browser cache;
means for determining that network connectivity to a wireless network is below a minimum threshold;
means for directing creation of a saved version of the web content associated with the first tab in a memory separate from the browser cache, based on the network connectivity;
means for causing the web content associated with the first tab to be purged from the browser cache;
means for receiving a request to reload the web content associated with the first tab;
means for reloading the web content associated with the first tab from the network if the network connectivity is above the minimum threshold; and
means for retrieving the saved version of the first tab, if the network connectivity is at or below the minimum threshold.

18. The apparatus of claim 17 wherein the saved version comprises an offline mode version of the web content associated with the first tab saved in a memory separate from the browser cache.

19. The apparatus of claim 17 further comprising means for updating one or more webpage resources associated with the first tab, wherein the saved version comprises a cached version of the one or more webpage resources, each webpage resource of the one or more webpage resources having a priority based on the network connectivity.

20. The apparatus of claim 19 wherein the saved version further comprises a cached version of non-cacheable webpage resources, the non-cacheable webpage resources comprising webpage resources that are not cacheable by convention.

21. The apparatus of claim 17 further comprising means for receiving a back command causing the browser to reload the web content associated with the first tab.

22. The apparatus of claim 17 wherein the purge request is associated with a closed tab.

23. The apparatus of claim 17 further comprising:
means for loading the web content associated with the first tab and determining a current page load speed;
means for comparing the current page load speed to an average page load speed;
means for determining based on the comparing, that the web content of the first tab is associated with a slow website,
means for designating, based on the determining, the website as a slow website; and
means for creating a cached version of resources associated with the slow website.

24. A non-transitory computer-readable medium comprising instructions for storage and retrieval of web content in a browser supporting a plurality of tabs in a multi-tab browsing architecture, that when executed cause a processor to:
receive, at a resource retrieval agent (RRA), a purge request to purge web content associated with a first tab of the plurality of tabs from a browser cache;
determine that network connectivity to a wireless network is below a minimum threshold;
direct a memory controller to create a saved version of the web content associated with the first tab in a memory separate from the browser cache, based on the determining;
cause the browser to purge the web content associated with the first tab from the browser cache;
receive, from the browser, a request to reload the web content associated with the first tab;
reload the web content associated with the first tab from the network if the network connectivity is above the minimum threshold; and
retrieve the saved version of the first tab if the network connectivity is at or below the minimum threshold.

25. The non-transitory computer-readable medium of claim 24 wherein the saved version comprises an offline mode version of the web content associated with the first tab saved in a memory separate from the browser cache.

26. The non-transitory computer-readable medium of claim 24 further comprising instructions to cause the processor to:
update one or more webpage resources associated with the first tab, wherein the saved version comprises a cached version of the one or more webpage resources, each webpage resource of the one or more webpage resources having a priority based on the network connectivity.

27. The non-transitory computer-readable medium of claim 26 wherein the saved version further comprises a cached version of non-cacheable webpage resources, the non-cacheable webpage resources comprising webpage resources that are not cacheable by convention.

28. The non-transitory computer-readable medium of claim 24 further comprising instructions to cause the processor to cause the browser to reload the web content associated with the first tab in response to a back command.

29. The non-transitory computer-readable medium of claim 24 wherein the purge request is associated with a closed tab.

30. The non-transitory computer-readable medium of claim 24 further comprising instructions that cause the processor to:
load the web content associated with the first tab and determining a current page load speed;
compare the current page load speed to an average page load speed;
determine based on the comparison, that the web content of the first tab is associated with a slow website,
designate, based on the determining, the website as a slow website; and
create a cached version of resources associated with the slow website.
